(19) United States
(12) Patent Application Publication
(10) Pub. No.: US 2024/0326930 A1
(43) Pub. Date: Oct. 3, 2024

(54) MODULAR AND CONVERTIBLE TRUCK BED SYSTEM

(71) Applicant: Focus Point Strategy LLC, Boulder, CO (US)

(72) Inventors: Caleb Sevian, Boulder, CO (US); Liam Gallagher, Austin, TX (US)

(21) Appl. No.: 18/622,892

(22) Filed: Mar. 30, 2024

Related U.S. Application Data
(60) Provisional application No. 63/493,120, filed on Mar. 30, 2023.

(51) Int. Cl. B62D 33/023; B60R 9/10; B62D 33/04

(52) U.S. Cl. CPC B62D 33/023; B60R 9/10; B62D 33/04

(57) ABSTRACT

Various aspects of the disclosure generally relate to a system for securing a bicycle on a truck bed. In one aspect, a modular and convertible truck bed system may serve to carry or mount a bicycle and serve as a base for truck bed cover, overlanding rack, and other truck bed accessories.

### CROSS-REFERENCE TO RELATED APPLICATIONS

This application claims priority under 35 U.S.C. § 119 to Provisional Patent Application No. 63/493,120, filed Mar. 30, 2023, entitled MODULAR AND CONVERTIBLE TRUCK BED SYSTEM, which is hereby incorporated by reference in its entirety.

### BACKGROUND

### Field of the Disclosure

Aspects of the disclosure relate to the field of vehicle accessories, specifically to modular components for a truck bed.

### Description of Related Art

Trucks, such as pickup trucks, generally offer a comfortable interior for passengers and a durable, exterior bed for storage and hauling gear. This combination of comfort and practical use have made trucks a popular option for transportation in both work and leisure. While stock arrangements of truck interiors and exteriors are suitable for a large variety of functions, many truck owners choose to enhance their truck's utility with one or more accessories.

Traditional truck bed accessories are acquired by the user to serve a specific purpose, such as a rack that can be used to carry a bike, or a bed cover, or a topper shell, or an overland rack. Various manufacturers have created products that specifically serve these needs. In some cases, add-on accessories may be purchased and integrated. For example, an overland rack may be purchased and then a bike rack may be purchased and might be attached to it. What is needed is a modular and convertible truck bed system capable of addressing multiple needs with a purpose-built design directed towards multiple configurations.

### SUMMARY

The systems, methods and devices of this disclosure each have several innovative aspects, no single one of which is solely responsible for the desirable attributes disclosed herein.

In one aspect, a modular and convertible system for a truck bed may include a first rail and a second rail mountable parallel to and spaced apart from the first rail. The first rail may be configured to separately secure a bicycle. The first and second rails may be further configured to support at least one cover selected from the group consisting of a bed cover and a camper shell.

The modular and convertible system for a truck bed may include a detachable first wheel lock that is coupled to the first rail and is configured to engage against a wheel.

The modular and convertible system for a truck bed may include a detachable second wheel lock that is coupled to the first rail and is offset from the first wheel lock, the second wheel lock configured to engage against a wheel that is different from the wheel engaged by the first wheel lock.

In the modular and convertible system for a truck bed, the first and second rails may form a plane, and the system may further comprise a plurality of bed cover planks. Each bed cover plank may be detachably coupled to and secured between the first and second rails. Each of the bed cover planks may be within the plane formed by the first and second rails.

In the modular and convertible system for a truck bed, each of the first and second rails may further include a horizontal channel along the length of each rail. Each of the plurality of bed cover planks may be configured to engage with the horizontal channel along the length of each rail and, staying between the first and second rails, slide along the horizontal channel along the length of each rail.

In the modular and convertible system for a truck bed, the first and second rails may form a plane. The system may further include a plurality of camper shell panels, with each camper shell panel detachably coupled to at least one of the first and second rails. Each camper shell panel may extend away from the plane formed by the first and second rail.

In the modular and convertible system for a truck bed, the plurality of camper shell panels may further include a first camper shell panel and a second camper shell panel. The first camper shell panel may be detachably coupled to the first rail. The second camper shell panel may be detachably coupled to the second rail. The system may further include a third camper shell panel that is coupled between the first camper shell panel and the second camper shell panel. The third camper shell panel may have a plane that is parallel to the plane formed by the first and second rail. The second and third camper shell panels may each separately have a plane that forms an angle with the plane formed by the first and second rail.

In the modular and convertible system for a truck bed, the second rail may be configured to separately secure a bicycle. The system may further include a detachable third wheel lock that is coupled to the second rail. A detachable fourth wheel lock may be coupled to the second rail and may be offset from the third wheel lock.

In one aspect, a rail for supporting a modular and convertible truck bed system may have a top, a bottom, a left side and a right side. The top of the rail may have a depression along the length of the rail. The left side of the rail may have a mounting point. The right side of the rail may have a mounting point. The bottom of the rail may have a mounting point.

The rail may be approximately the length of a truck bed sidewall.

The depression along the length of the rail may be a V-groove.

The mounting point on the left side of the rail may be a channel along the length of the rail.

The mounting point on the right side of the rail may be a channel along the length of the rail.

The channels on the left and right sides of the rail may be T-channels.

The rail may have a left half and a right half along a top-down bisection of the rail. The left half of the rail may be a mirror image of the right half.

In one aspect, a truck bed system for securing a bicycle may include a rail configured for mounting to a sidewall of a truck bed. The rail may have a top and a depression running along the top of the rail for securing a wheel of a bicycle. The system may have a first wheel lock that is adjustably coupled to the rail and configured to be positioned at a plurality of points along the rail. The system may have a second wheel lock that is coupled to the rail, and the second wheel lock may be adjustable in length.

In the truck bed system for securing a bicycle, the first wheel lock may be slidable along the rail, and the second wheel lock may be rotatably coupled to the rail.

In the truck bed system for securing a bicycle, the rail may have a length approximately equal to that of the truck bed side wall.

In the truck bed system for securing a bicycle, the first and second wheel locks may be removable from the rail.

In the truck bed system for securing a bicycle, the first and second wheel locks may be interchangeable with each other.

In the truck bed system for securing a bicycle, the rail may further provide a base for a camper shell.

In the truck bed system for securing a bicycle, the rail may further provide a base for a bed cover.

The foregoing has outlined rather broadly the gestures and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of this disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a perspective view illustrating a truck having one aspect of a bed-mounted rail with a bicycle secured to the rail.

FIG. 2 is a perspective view illustrating one aspect of a truck bed system for securing a bicycle with two bicycles secured.

FIG. 3 is a perspective view illustrating one aspect of a rail with wheel locks.

FIG. 4 is a perspective view illustrating the rail with wheel locks from FIG. 3, from the opposite side.

FIG. 5 is a perspective partial view illustrating one aspect of a rail.

FIG. 6 is a plan end view illustrating the rail from FIG. 5.

FIG. 7 is a perspective view illustrating one aspect of a modular and convertible truck bed system, with two bicycles secured, including a bed cover.

FIG. 8 is a perspective view illustrating one aspect of the truck bed system from FIG. 7 without the bicycles and wheel locks.

FIG. 9 is a perspective view illustrating one aspect of a modular and convertible truck bed system with a bed cover.

FIG. 10 is a plan end view illustrating the modular and convertible truck bed system and bed cover of FIG. 9.

FIG. 11 is a perspective view illustrating a truck with one aspect of a modular and convertible truck bed system with a bed cover mounted to the truck.

FIG. 12 is a perspective view illustrating the modular and convertible truck bed system with a bed cover from FIG. 11.

FIG. 13 is a plan end partial view illustrating the rail and bed cover from FIG. 12.

FIG. 14 is a plan end partial view illustrating the bed cover from FIG. 12.

FIG. 15 is a perspective view illustrating the modular and convertible truck bed system with a bed cover from FIG. 12.

### DETAILED DESCRIPTION

Various aspects of the disclosure are described more fully herein with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based at least in part on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure may be embodied by one or more elements of a claim.

In one aspect a modular and convertible truck bed system includes a rail that may be secured to the sidewall of a truck. The rail may be used to secure a bicycle, for example a road, mountain, cruiser, cyclocross, beach, child's, or any other kind of bike. Rather than from a rear hitch or the roof, as may be found in conventional systems, a bike may be mounted to the sidewall of the bed and in-line with the body of the truck. Any truck with a bed long enough for a bicycle may be used, for example trucks made by

FORD, NISSAN, TOYOTA, CHEVROLET, GMC, RAM, HONDA and others. In one aspect, the rail extends the full length of the bed and is longer than would be necessary to only secure the bicycle. In one aspect, the rail is shorter than the bed length and long enough to secure a bicycle. Advantages of this system include enhanced aerodynamics by aligning the bike with and behind the body of the truck, instead of on the roof, for example. Securing a bicycle on the sidewall (either a direct mount or by the rail) is easier than lifting the bicycle to the height of the roof, which can be difficult to reach. This also has the advantage over a hitch mount of leaving the tailgate area free and accessible as normal, without bicycles or mounts in the way of the tailgate or rear of the bed.

In one aspect, a second rail may be added to the sidewall on the opposite side of the bed from the first rail, and a second bike secured to the second rail. The second rail may be a mirror image of the first rail, or it may have a different configuration.

In one aspect, the two rails may be used to secure a cover for the bed. Examples of covers include a bed cover (i.e. cargo bed cover and tonneau cover) and a camper shell (i.e. camper shell, truck topper, topper, hard topper, soft topper, truck cap).

In one aspect, if space allows, then one or more bikes may be mounted on the system with a cover also in place. In one aspect, the system may be used to carry one or more bikes. Leaving the bikes in place, the driver may add a cover with the bikes still being transported. The system may be converted to overlanding use by removing the bikes and cover and installing an overlanding rack onto either or both rails. The driver may convert it to camping by removing the overlanding rack and installing a camper shell.

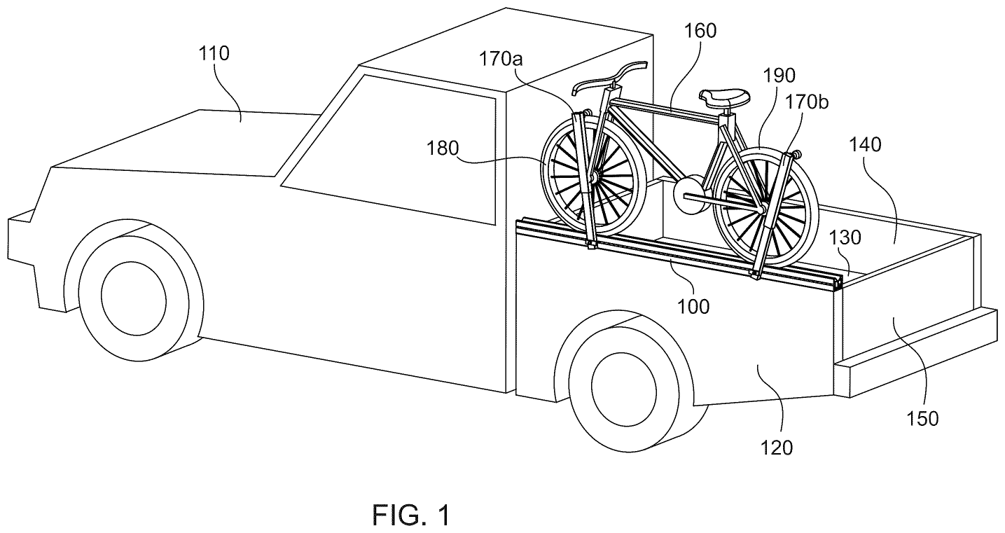

FIG. 1 is a perspective view illustrating a truck having one aspect of a bed-mounted rail with a bicycle secured to the rail. Rail 100 may be secured to truck 110. The term “truck” includes any consumer-grade vehicle with a bed, for example traditional trucks (light, medium or heavy duty), pickup trucks and “half truck” models such as a CHEVY El Camino and JEEP Gladiator. Truck includes sloped-back models such a HONDA Ridgeline. Truck beds may vary in length from, for example, 4 feet (HYUNDAI Santa Cruz), 5 feet, 6 feet, to 8 feet (FORD F-150 long bed), in other words, typically between 4 and 8 feet. One of skill in the art will recognize that vehicles with a bed, but not explicitly described or mentioned, are included with the word “truck.”

Rail 100 is securely attached to sidewall 120 of bed 130. In one aspect, truck 110 may have bed 130 with sidewalls 120 and 140, and tailgate 150. Bike 160 may be secured to rail 100 with wheel lock 170a and wheel lock 170b (collectively referred to as wheel locks 170). Wheel lock 170a may secure tire 180 of bike 160 while wheel lock 170b may secure tire 190 of bike 160.

Rail 100 may be secured with bolts, clamps, locks, and other mechanisms or means, whether removable or intended to be permanent (not illustrated in FIG. 1) to sidewall 120. In one aspect, rail 100 is integral (built-in) to sidewall 120. In one aspect, rail 100 is a length appropriate to a vehicle make and model to serve as an element in a modular and convertible truck bed system, or approximately the length of a truck bed sidewall. In this aspect, a rail length (for example, rail 100, rail 300 and rail 700) may be approximately equal to the truck bed sidewall length, and may provide support and security for other elements of the truck bed system, for example a cover or overlanding rack. In one aspect, a “length approximately equal” may be within 20% of a bed length. In one aspect, a “length approximately equal” may be within 15% of a bed length. In one aspect, a “length approximately equal” may be within 10% of a bed length. In one aspect, a “length approximately equal” may be within 5% of a bed length. In one aspect, a “length approximately equal” may be within 4% of a bed length. In one aspect, a “length approximately equal” may be within 3% of a bed length. In one aspect, a “length approximately equal” may be within 2% of a bed length. In one aspect, a “length approximately equal” may be within 1% of a bed length. A rail may be metal (for example titanium, aluminum, steel, etc.) fiberglass, a composite, a plastic, or any other material suitably strong. Aspects of various truck beds and their configurations will dictate exactly how long of a rail is needed in a modular and convertible system in order to include other elements of the system, for example a cover. As illustrated in FIG. 1, as an element of a modular and convertible truck bed system, rail 100 is approximately the same length as bed 130.

In one aspect of a truck bed system for securing a bicycle, rail 100 may be shorter than the length of a truck bed sidewall but long enough to provide support and security for bike 160. For example, rail 100 may be 6 feet long and mounted to a sidewall of a longer bed, for example an 8 foot bed. In one example of a truck bed system for securing a bicycle, rail 100 may be approximately the same length as a sidewall to which it is mounted or a part of. In one example of a truck bed system for securing a bicycle, rail 100 may be 6 feet long and mounted to a sidewall of a shorter bed, for example a 5 foot bed. The size of bicycles will dictate exactly how long of a rail is needed in a truck bed system for carrying a bicycle. As illustrated in FIG. 1, in a truck bed system for carrying a bicycle, rail 100 is approximately the same length as bed 130. Although not illustrated in FIG. 1, rail 100 may be longer than or shorter than bed 130 in a truck bed system for carrying a bicycle.

The length of rail 100 as an element in a modular and convertible truck bed system may be the same, or may differ, from the length of rail 100 in a truck bed system for securing a bicycle. Rail 100 may be attached to either side of the truck bed, for example to sidewall 140 instead of sidewall 120. In one aspect, with rail 100 attached to sidewall 140 (not illustrated in FIG. 1), wheel locks 170 may be attached to the opposite side of rail 100 for ease of access to a user.

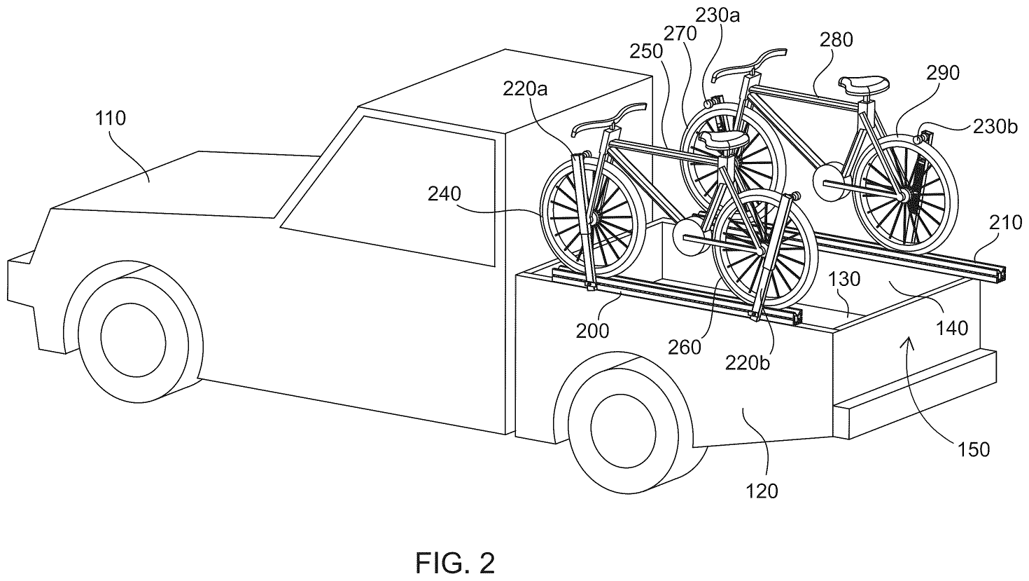

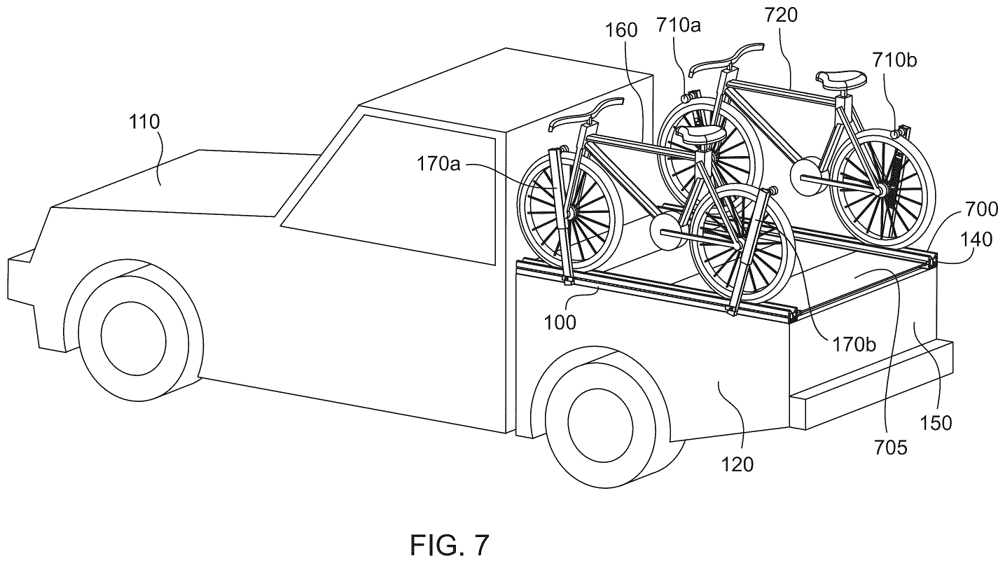

FIG. 2 is a perspective view illustrating one aspect of a truck bed system for securing a bicycle with two bicycles secured. See FIG. 7 for an example of rails with bicycles secured that illustrate both a modular and convertible truck bed system and a truck bed system for securing a bicycle. Returning to FIG. 2, in one aspect, rail 200 is secured to sidewall 120 and rail 210 is secured to sidewall 140 of bed 130. Rail 210 may be parallel, spaced apart and opposite to rail 200, as illustrated in FIG. 2. Rails 200 and 210 may be identical to rail 100 except in length relative to sidewalls 120 and 140.

Rail 200 may include wheel lock 220a and wheel lock 220b (collectively referred to as wheel locks 220). Rail 210 may include wheel lock 230a and wheel lock 230b (collectively referred to as wheel locks 230).

Wheel lock 220a may secure wheel 240 of bike 250. Wheel lock 220b may secure wheel 260 of bike 240. Wheel lock 230a may secure wheel 270 of bike 280. Wheel lock 230b may secure wheel 290 of bike 280. Although illustrated in FIG. 2 with rail 200 being shorter than bed 130 and rail 210 being longer than bed 130, one of skill in the art will recognize that rails in a truck bed system for securing bicycles may be the same length, for example both rails may be shorter than the bed length (not illustrated), or both rails may longer than the bed length (not illustrated), or both rails may be the same length as the bed (see FIG. 7). One example where a rail with a length greater than the bed is advantageous includes trucks with a bed length shorter than needed to fit a bicycle.

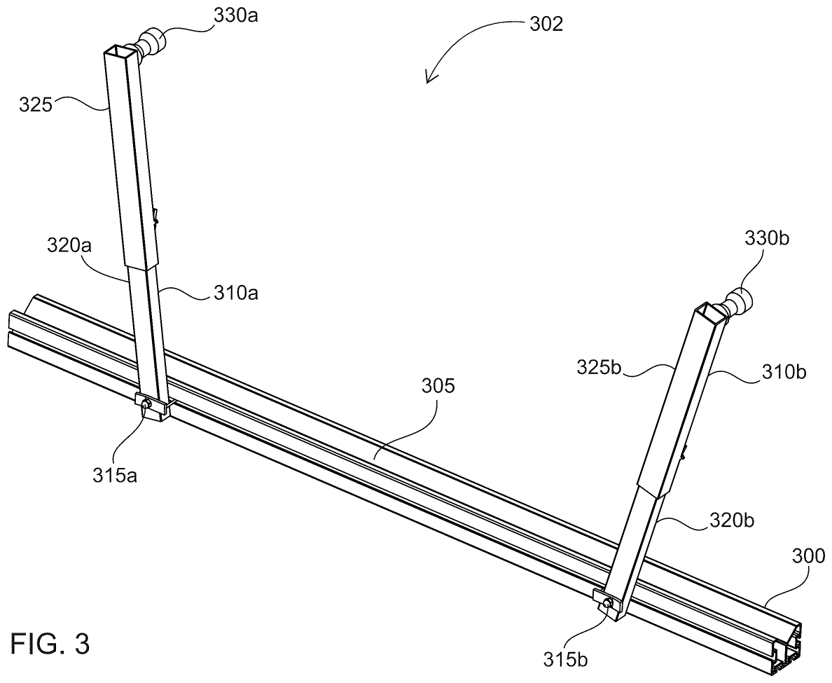

FIG. 3 is a perspective view illustrating one aspect of a rail and wheel locks. FIG. 3 may illustrate truck bed system 302 for securing a bicycle. In one aspect, FIG. 3 may be an element of a modular and convertible truck bed system. Rail 300 may be similar or identical to any of rails 100, 200 and 210. Rail 300 may include a depression in the top of rail 300, one example being V-groove 305.

Wheel lock 310a and wheel lock 310b (collectively referred to as wheel locks 310) may be detachably mounted to rail 300 at a variety of mounting points along rail 300. In one aspect, fastener 315a secures wheel lock 310a to rail 300 and fastener 315b secures wheel lock 310b to rail 300 (collectively referred to as fasteners 315). Fasteners 315 may be screw, latch, lever, pin, pressure, bolt and any other type of detachable or adjustable fastener. Fasteners 315 provide adjustability in positioning wheel locks 310 in accordance with the size and type of bicycle being mounted. Wheel locks 310 can be slid to their left or right, moving either one or both of them, and removed entirely from rail 300. Wheel locks 310 may be rotated around fasteners 315 in order to hold the wheels of a bicycle in place, and when suitably positioned, wheel locks 310 may be removably fixed in place to secure a bicycle.

Wheel locks 310 include lower arm 320a and lower arm 320b (collectively referred to as lower arms 320) and upper arm 325a and upper arm 325b (collectively referred to as upper arms 325). In one aspect, upper arms 325 connect to and adjustably extend from lower arms 320, such that wheel locks 310 may be adjustable in length. Upper arms 325 include tire grip 330a and tire grip 330b (collectively referred to as tire grips 330), which are positioned towards an end of upper arms 325. In one aspect, tire grips 330 may be shaped to conform around and secure the tire of a bicycle. Tire grips 330 may be shaped to accommodate a variety of tire sizes and styles (for example, from road tires to fat tires. Tire grips 330 may be replaceable, or substitutable, or augmentable depending on what is needed to secure a bicycle.

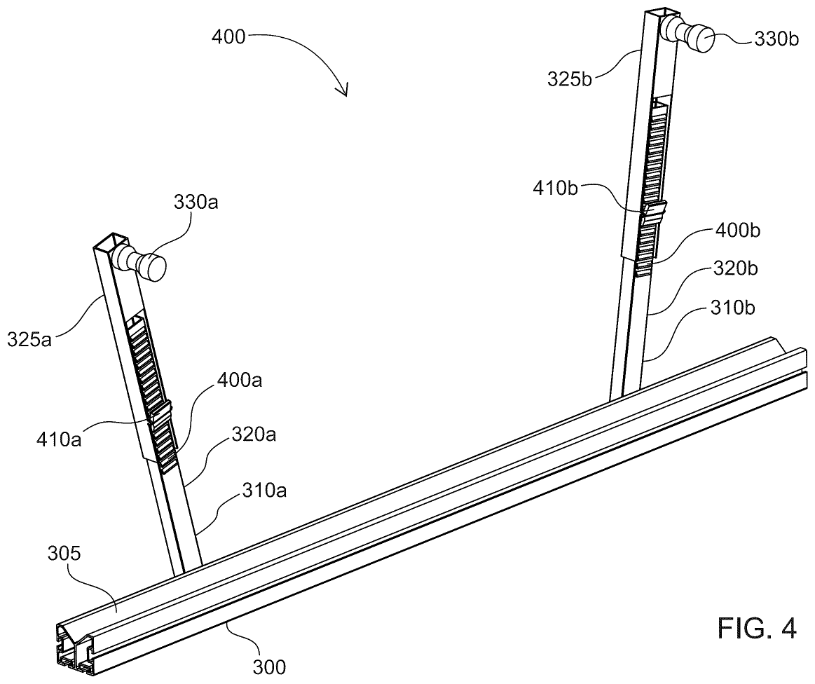

FIG. 4 is a perspective view illustrating rail 300 and wheel locks 310 from FIG. 3. FIG. 4 may illustrate an element of modular and convertible truck bed system 400. In one aspect, FIG. 4 may be a truck bed system for securing a bicycle. Lower arms 320 may include teeth 400a along lower arm 320a and teeth 400b along lower arm 320b (collectively referred to as teeth 400). Upper arms 325 may include pawl 410a on upper arm 325a and pawl 410b on upper arm 325b (collectively referred to as pawls 410). Pawls 410 may be actively biased towards teeth 400 with a spring, for example. Depressing one of pawls 410 may disengage it from teeth 400 and allow one of upper arms 325 to be slid along one of lower arm 320, providing length adjustability to wheel locks 310. After adjustment, releasing one of pawls 410 may cause one of pawls 410 to re-engage with teeth 400 and fix a length for one of wheel locks 310. Length adjustability may assist in fitting different sizes and styles of bicycle wheels, as well as making it easier to secure a bicycle. One of ordinary skill will recognize that teeth 400 and pawl 410 are one of many mechanisms for adjustable length wheel locks 310.

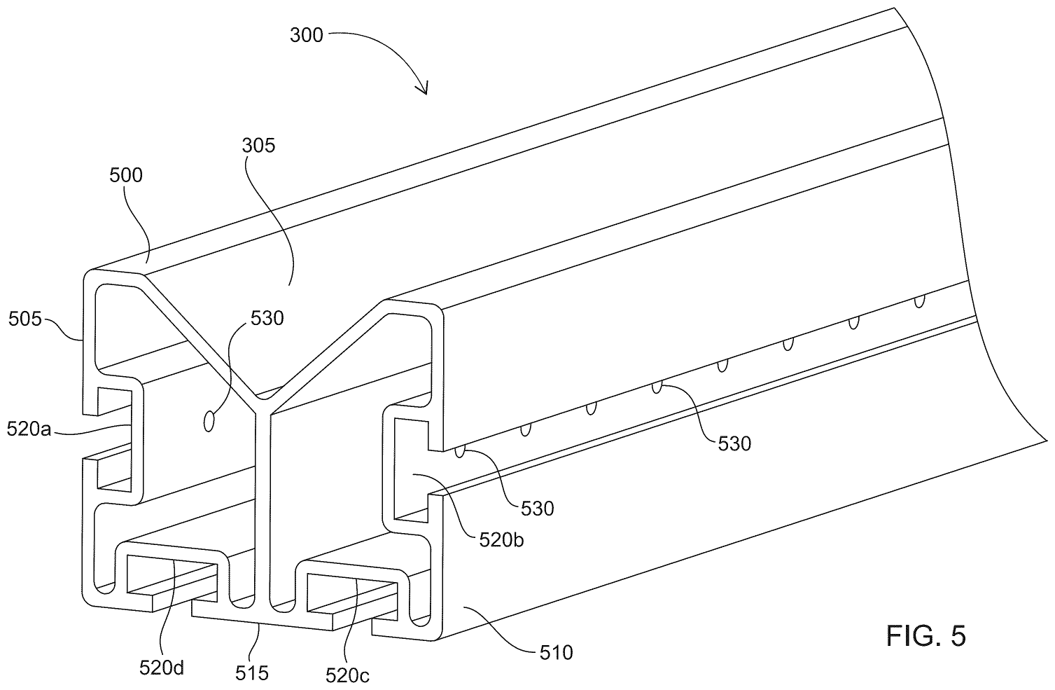

FIG. 5 is a perspective partial view illustrating one aspect of rail 300. Rail 300 may include top 500, left side 505, right side 510 and bottom 515. Assignment of left side 505 and right side 510 is arbitrary. Top 500 may include a depression for stabilizing, securing, positioning, capturing, or otherwise holding a bicycle tire. In one aspect, the depression is V-groove 305. In one aspect, V-groove 305 extends along the entire top 500 of rail 300. In one aspect, V-groove is interrupted and does not extend along the entire top 500. Mounting points along left side 505, right side 510 and bottom 515 include channel 520a, channel 520b and channel 520c. In one aspect and illustrated in FIG. 5, mounting points include channel 520d (collectively referred to as channels 520). In one aspect, channels 520 may be T-channels as illustrated in the Figures.

In one aspect, channels 520a and 520b may include positioning holes 530. Positioning holes 530 may be used, for example, to fix wheel locks 310 in place with fasteners 315 (see FIG. 3), where a pin (not illustrated) from one of fasteners 315 inserts into one of positioning holes 530. In one aspect, one of, or both, channels 520c and 520d may be used to attach rail 300 to the sidewall of a truck bed, for example truck 110. In one aspect, one of channels 520a or 520b (depending on which side of the truck bed rail 300 is attached) may be used to attach rail 300 to the sidewall of a truck bed, for example truck 110. In one aspect, using one of channels 520a and 520b to attach rail 300 to the truck bed sidewall may interfere with a bed cover. One of ordinary skill will recognize that channel types other than a T-channel may be used in any of channels 520. Although FIG. 5 illustrates channels 520 as being the same type of channel as between them, the channel type may differ between them. For example, mounting points along bottom 515 may be dedicated attachments particular to a make and model of truck.

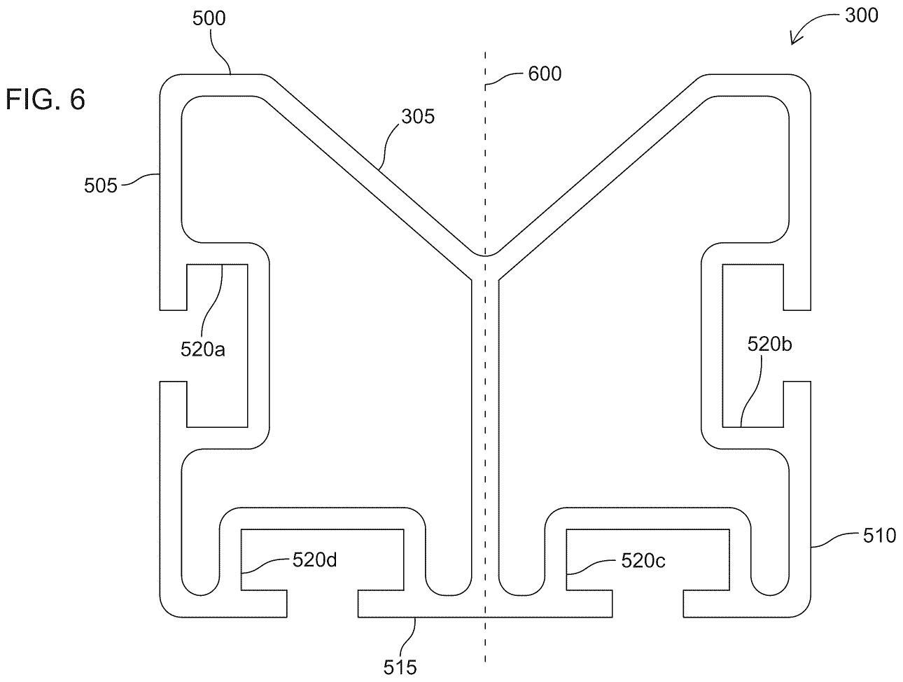

FIG. 6 is a plan end view illustrating rail 300 from FIG. 5. In one aspect, rail 300 is a mirror copy between its left and right sides, along dotted line 600. Advantages to this may include ease of manufacturing, interchangeability between rails attached to either side of the truck bed and interchangeability between fastening/mounting/attaching devices (whether to the truck bed sidewall, for wheel locks, bed covers, overlanding racks, and other hardware mounted to the rails). In one aspect, a rail in either of a truck bed system for securing a bicycle or a modular and convertible truck bed system may not have left and right sides that are identical to one another.

FIG. 7 is a perspective view illustrating one aspect of a modular and convertible truck bed system, with two bicycles secured, including a cover. A modular and convertible truck bed system may include rail 100 attached to sidewall 120, and rail 700 attached to sidewall 140. In one aspect, between rails 100 and 700 is a cover for the truck bed. Examples of covers include camper shell (i.e. truck topper, topper, hard topper, soft topper, truck cap) and bed cover (i.e. cargo bed cover and tonneau cover). In FIG. 7, bed cover 705 is illustrated along with wheel locks 170 for securing bike 160 and wheel lock 710a and wheel lock 710b (collectively referred to as wheel locks 710) for securing bike 720. Rail 700 may be identical to rail 100 except for its placement, parallel to and separated from rail 100.

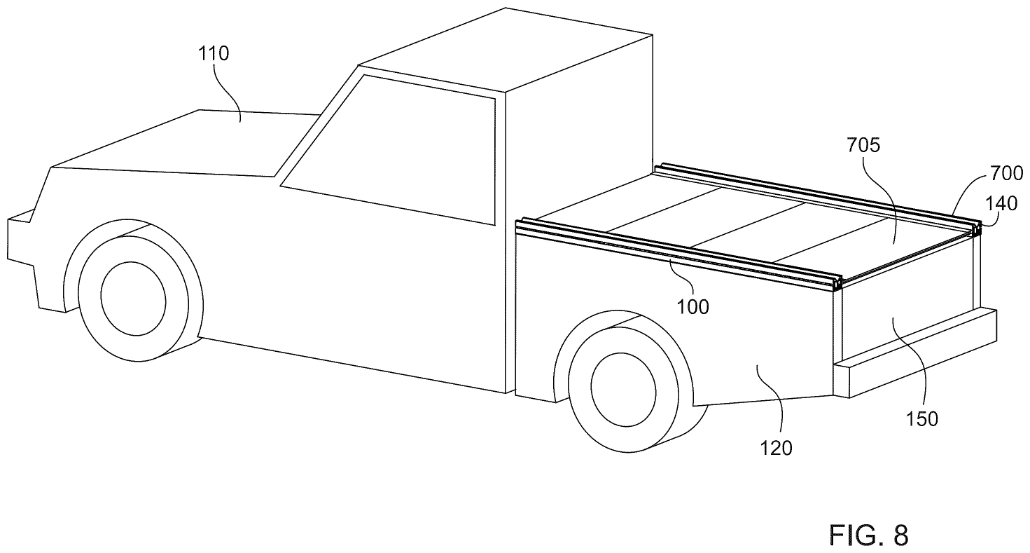

Bed cover 705 may provide security for items in the truck bed from theft, from weather and the elements. Bed cover 705 may slide in and out of rails 100 and 700. Bed cover 705 may be multiple, separate pieces or it may be a single, connected structure. Bed cover 705 may be made from a metal, composites, plastic, fiberglass or other suitable material. Rails 100 and 700 may extend the length of the bed in order to provide support to and help seal bed cover 705 over the truck bed. Although two bicycles are illustrated in FIG. 7, one of skill in the art will recognize that the convertible and modular system may carry a single bicycle on either side of the bed, or, as illustrated in FIG. 8, a cover with no bicycles.

FIG. 8 is a perspective view illustrating one aspect of the modular and convertible truck bed system from FIG. 7 with the bicycles and wheel locks removed. In a convertible and modular truck bed system, rails 100 and 700 may have approximately the same length as the truck bed. One advantage of this is to assist in sealing a cover to the bed and body of the truck in order to secure the bed from the elements and help with theft prevention.

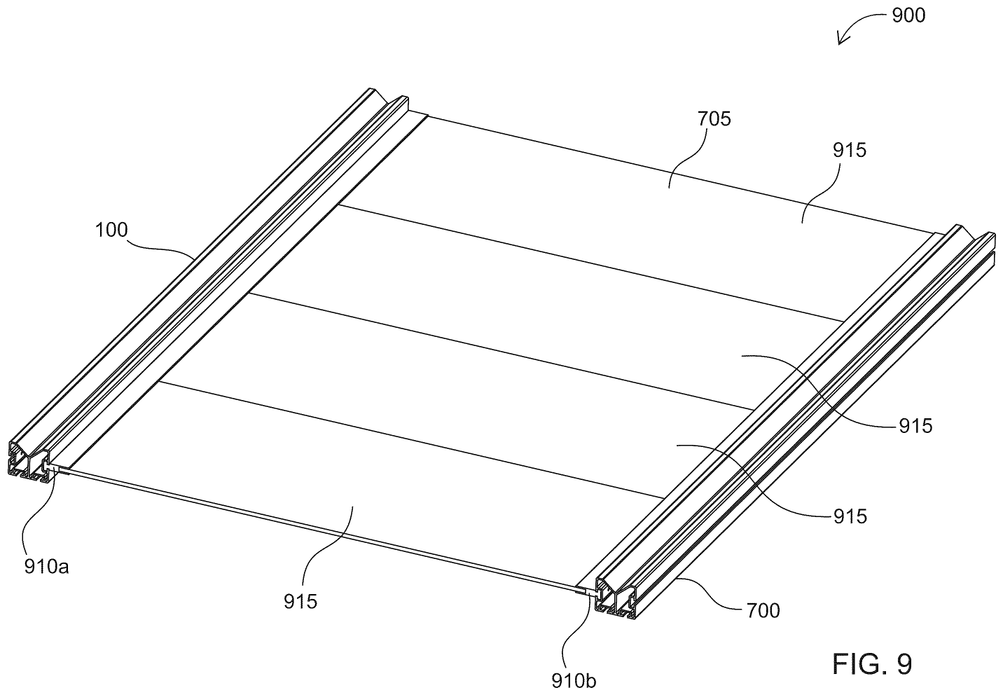

FIG. 9 is a perspective view illustrating one aspect of a modular and convertible truck bed system with a bed cover. One aspect of modular and convertible truck bed system 900 is illustrated with a cover and no bicycles (see FIG. 7 with bicycles). In one aspect, the cover may be bed cover 705. In one aspect, bed cover 705 may include adapter 910a and adapter 910b (collectively referred to as adapters 910), which may have a “T” shape for engaging, coupling, or sliding into rails 100 and 700. For example, adapter 910a may slide into rail 100 and adapter 910b may slide into rail 700. One of planks 915 may fit into both adapters 910, on each end, as illustrated in FIG. 9. Adapters 910 may be metal, plastic, fiberglass, a composite, or any material suitably strong.

In one aspect, planks 915 may engage with each other in a water-tight manner, or in a way to deter theft. In one aspect bed cover 705 may further engage with or seal to the truck bed (not illustrated in FIG. 9) to keep out the elements, wind, rain, sun and to deter or prevent theft.

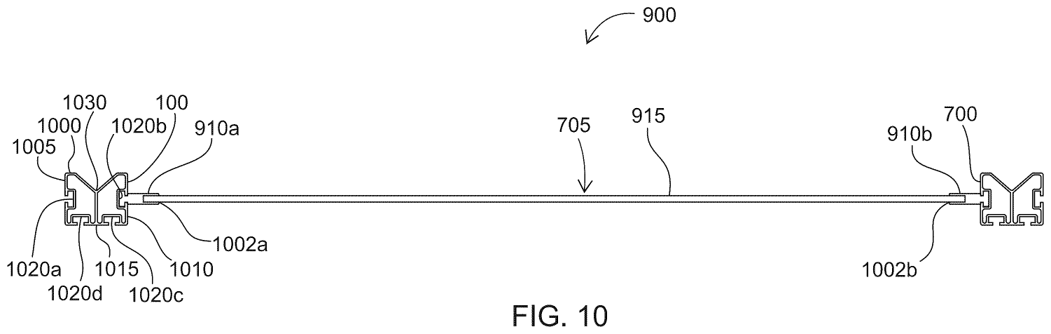

FIG. 10 is a plan end view illustrating the modular and convertible truck bed system and cover of FIG. 9. Modular and convertible truck bed system 900 in one aspect may include bed cover 705. When mounted to the bed of a truck (not illustrated in FIG. 10), rails 100 and 700 form a plane between them, as a straight line from one to the other. Bed cover 705 forms a plane that is parallel to and within the plane formed by rails 100 and 700, as illustrated in FIG. 10. Adapters 910 may engage with planks 915 through mounting points, for example channel 1002a on adapter 910a and channel 1002b on adapter 910b (collectively referred to as channels 1002). In one aspect and illustrated in FIG. 10, channels 1002 may be U-shaped.

In one aspect, rail 100 and rail 700 may be identical to one another, and identical to rail 300 from FIG. 5 (except in length). Features and parts will be described with respect to rail 100 that may apply equally to rail 700. Rail 100 may include top 1000, left side 1005, right side 1010 and bottom 1015. Assignment of left side 1005 and right side 1010 is arbitrary. Top 1000 may include a depression for stabilizing, securing, positioning, capturing, or otherwise holding a bicycle tire. In one aspect, the depression is V-groove 1030. In one aspect, V-groove 1030 extends along the entire top 1000 of rail 100. In one aspect, V-groove is interrupted and does not extend along the entire top 1000. Mounting points along left side 1005, right side 1010 and bottom 1015 include channel 1020a, channel 1020b and channel 1020c. In one aspect and illustrated in FIG. 10, mounting points include channel 1020d (collectively referred to as channels 1020). In one aspect, channels 1020 may be T-channels as illustrated in the Figures.

In one aspect, channels 1020a and 1020b may include positioning holes (not visible in FIG. 10). The positioning holes may be used, for example, to fix wheel locks with fasteners, where a pin (not illustrated) from one of the fasteners inserts into one of the positioning holes. In one aspect, one of, or both, channels 1020c and 1020d may be used to attach rail 100 to the sidewall of a truck bed, for example truck 110. One of ordinary skill will recognize that channel types other than a T-channel may be used in any of channels 1020. Although FIG. 10 illustrates channels 1020 as being the same type of channel as between them, the channel type may differ between them. For example, mounting points along bottom 1015 may be dedicated attachments particular to a make and model of truck.

In one aspect, adapter 910a, which is T-shaped, fits into channel 1020b, which is T-shaped, on right side 1010 of rail 100. At the right side of bed cover 705, adapter 910b fits into a corresponding channel on rail 700, which may be mirroring the configuration of rail 100.

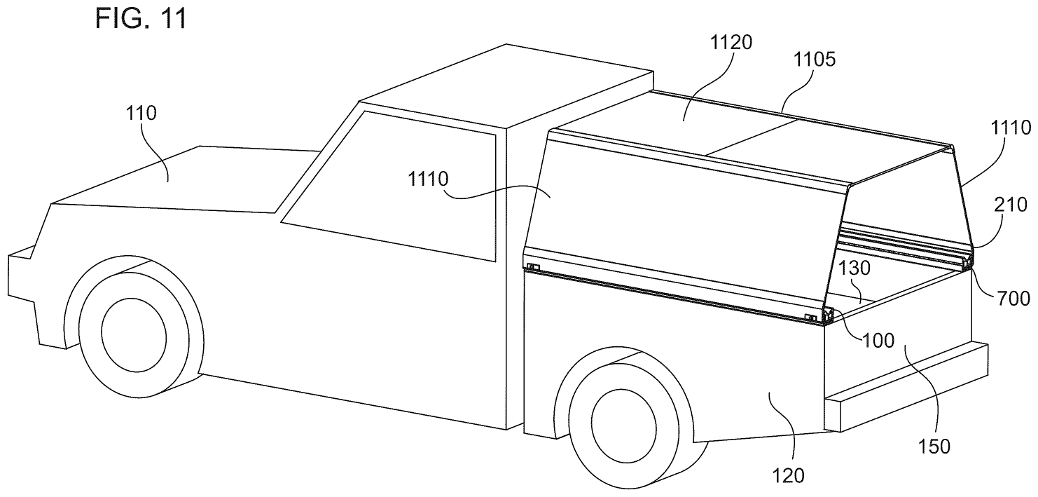

FIG. 11 is a perspective view illustrating a truck with one aspect of a modular and convertible truck bed system with a cover mounted to the truck. A modular and convertible truck bed system may include rail 100 attached to sidewall 120, and rail 700 attached to sidewall 140. Rail 700 may be identical to rail 100 except for its placement, parallel to and separated from rail 100. In one aspect, between rails 100 and 700 is a cover for the truck bed. Examples of covers include a camper shell (i.e. truck topper, topper, hard topper, soft topper, truck cap) and bed cover (i.e. cargo bed cover and tonneau cover). Other carrying systems may mount to the modular and convertible truck bed system, for example an overlanding rack (not illustrated). In FIG. 11, camper shell 1105 is mounted to truck 110 through rails 100 and 700. covers the truck bed.

Camper shell 1105 may include camper shell panels, for example side panels 1110 and roof 1120. Camper shell 1105 may seal to truck 110 sufficiently to reduce or eliminate water from getting into bed 130. In one aspect, camper shell 1110 may include windows and a rear gate (not illustrated). Popular examples of camper shells are made by LEER, SNUGTOP and A.R.E. A camper shell provides cover, protection from the elements and theft, to items in truck bed 130. Camper shell 1105 may be made from any materials commonly used to make camper shells, including fiberglass, metal, plastic and composites. In contrast to existing models, camper shell 1105 is user-removable and swappable with a different cover (for example bed cover 705) using the modular and convertible truck bed system. Advantages of this system include storability of cover parts, as side panels 1110, roof 1120 and planks 915 (see FIG. 9) take relatively little space as compared to traditional camper shells. A user can quickly and conveniently swap a bed cover used during the week to protect tools, for a camper shell to take out on the weekend. At the end of the trip, the camper shell can be removed and stored where the bed cover was kept, with wheel locks added to transport bicycles for midweek riding. The system provides interchangeability between popular truck accessories: bicycle racks, (bed) covers, overlanding racks.

Although not illustrated in FIG. 11, one of skill in the art will recognize that a bed cover and a camper shell may be simultaneously mounted in a modular and convertible truck bed system.

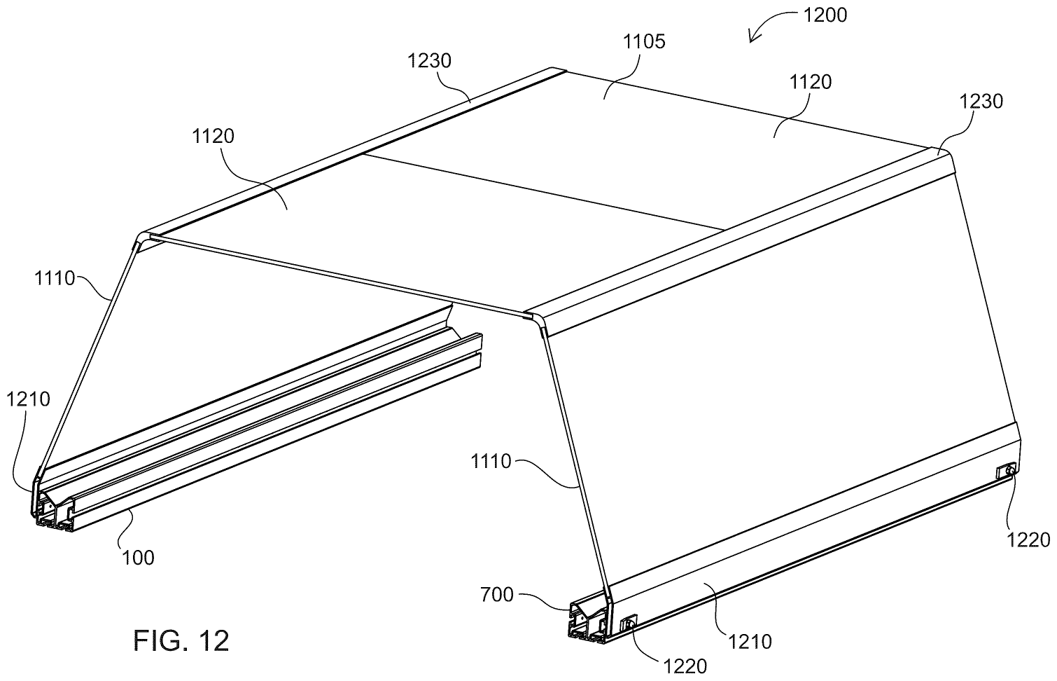

FIG. 12 is a perspective view illustrating the modular and convertible truck bed system with a cover from FIG. 11. Modular and convertible truck bed system 1200 may include rails 100 and 700, and camper shell 1105. Side panels 1110 may be flat in order to facilitate stacking and storage. Roof 1120 may also be a flat panel for the same reason. In one aspect, roof 1120 may be multiple panels in order to ease handling and storage. Each of side panels 1110 may attach to rails 100 either directly or through rail couplers 1210. Rail couplers 1210 may attach to rails 100 and 700 with bolts 1220, or latches, screws, pins, or other conventional attachment devices.

In one aspect, side panels 1110 may attach directly to roof 1120. In one aspect, side panels 1110 may attach to roof 1120 through roof couplers 1230. Side panels 1110, roof 1120, rail couplers 1210 and roof couplers 1230 are all meant to be removable and easily stored as part of modular and convertible truck bed system 1200. Side panels 1110 may optionally include windows and other features common in conventional camper shells. Although not illustrated in FIG. 12, one of skill in the art will recognize that end pieces may be included as part of camper shell 1105 in order to complete coverage over a truck bed.

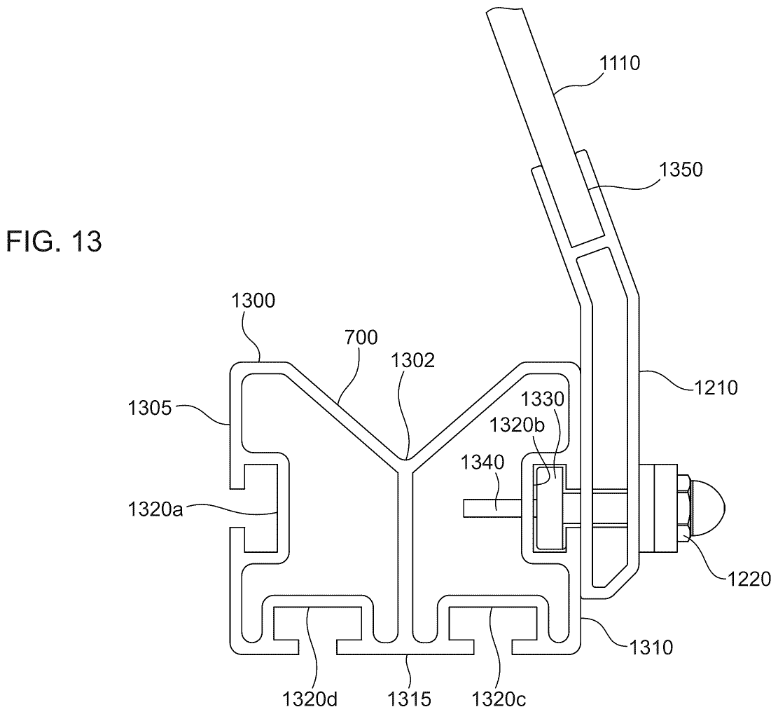

FIG. 13 is a plan end partial view illustrating the rail and cover from FIG. 12. In one aspect, rail 700, which may be mounted to a truck bed sidewall (not illustrated in FIG. 13) through mounting points and may have mounting points into which camper shell 1105 is secured. Rail 700 may include top 1300, left side 1305, right side 1310 and bottom 1315. Assignment of left side 1305 and right side 1310 is arbitrary. Top 1300 may include a depression for stabilizing, securing, positioning, capturing, or otherwise holding a bicycle tire. In one aspect, the depression is V-groove 1302. In one aspect, V-groove 1302 extends along the entire top 1300 of rail 700. In one aspect, V-groove is interrupted and does not extend along the entire top 1300. Mounting points along left side 1305, right side 1310 and bottom 1315 include channel 1320a, channel 1320b and channel 1320c. In one aspect and illustrated in FIG. 13, mounting points include channel 1320d (collectively referred to as channels 1320). In one aspect, channels 1320 may be T-channels as illustrated in the Figures.

In one aspect, one of, or both, channels 1320c and 1320d may be used to attach rail 700 to the sidewall of a truck bed, for example truck 110. Channel 1320b may be used to secure nut 1330 in place while a fastener, for example bolt 1220 secures rail coupler 1210 to rail 700. In one aspect, channels 1320a and 1320b may include positioning holes (not directly illustrated in FIG. 13). Positioning holes may be used, for example when camper shell 1105 is removed, to fix wheel locks in place where a pin (not illustrated) from one of the fasteners inserts into one of the positioning holes. As illustrated in FIG. 13 and in one aspect, bolt end 1340 may align with one of the positioning holes and assist with securing camper shell 1105. In one aspect, channel 1320a may be used to attach rail 700 to the sidewall of a truck bed, for example truck 110. One of ordinary skill will recognize that channel types other than a T-channel may be used in any of channels 1320. Although FIG. 13 illustrates channels 1320 as being the same type of channel as between them, the channel type may differ between them. For example, mounting points along bottom 1315 may be dedicated attachments particular to a make and model of truck, instead of T-channels.

Rail coupler 1210 may attach to rail 700 (and by extension, a rail coupler may attach to rail 100, though not illustrated in FIG. 13) through the mounting point of channel 1320b. Rail coupler 1210 may have U-channel 1350 into which side panel 1110 is secured.

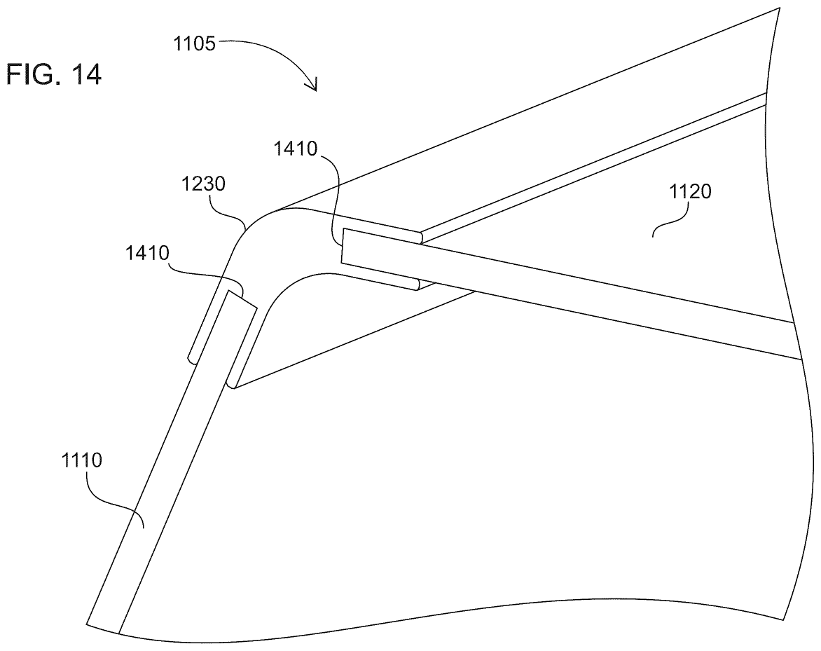

FIG. 14 is a plan end partial view illustrating the cover from FIG. 12. A partial view of camper shell 1105 includes roof 1120 (which may be one or more panels, not illustrated in FIG. 14) attached to side panel 1110 through roof coupler 1230. In one aspect, roof coupler 1230 may include U-channels 1410 for securing roof 1120 and side panel 1110.

One of skill in the art will recognize, and as described herein, that reference to “truck bed system” and “modular and convertible truck bed system” is not limited to a truck bed (i.e. base floor of the bed) itself but may include the area above the truck bed and the sidewalls of the bed, above the wheels, as well as other aspects, features and components that may be part of the truck bed. The aspects and features mentioned and described together with one or more of the previously detailed examples and figures, may as well be combined with one or more of the other examples in order to replace a like feature of the other example or in order to additionally introduce the feature to the other example.

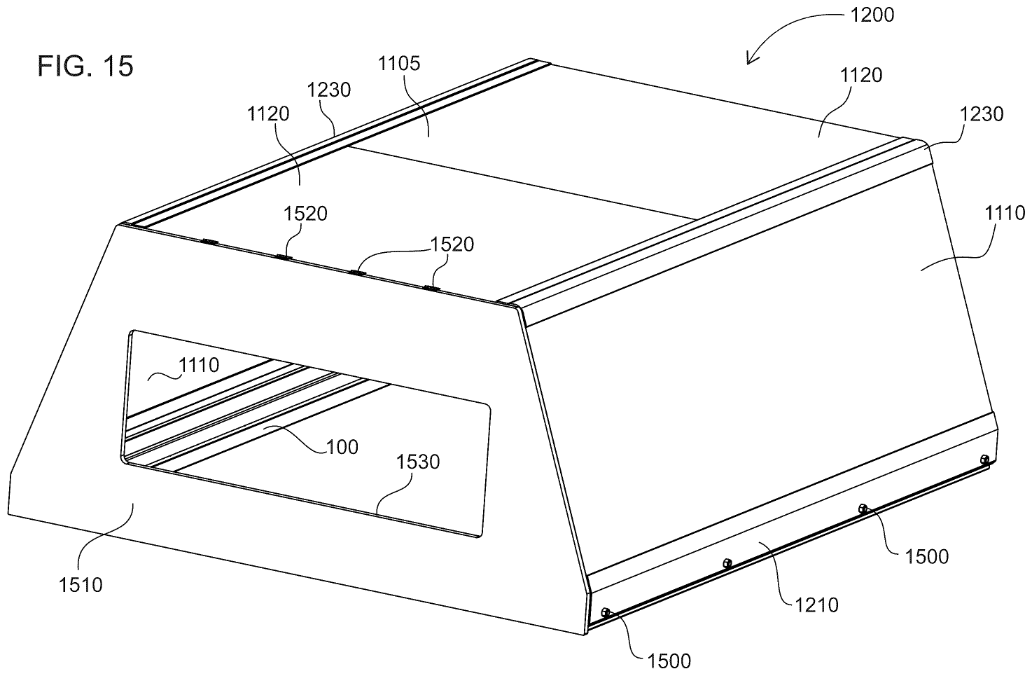

FIG. 15 is a perspective view illustrating the modular and convertible truck bed system with a bed cover from FIG. 12. Modular and convertible truck bed system 1200 may include rails 100 and 700 (not visible in FIG. 15), and camper shell 1105. Side panels 1110 may be flat in order to facilitate stacking and storage. Roof 1120 may also be a flat panel for the same reason. In one aspect, roof 1120 may be multiple panels in order to ease handling and storage. Each of side panels 1110 may attach to rails 100 either directly or through rail couplers 1210. Rail couplers 1210 may attach to rails 100 and 700 with bolts 1500, or latches, screws, pins, or other conventional attachment devices.

In one aspect, side panels 1110 may attach directly to roof 1120. In one aspect, side panels 1110 may attach to roof 1120 through roof couplers 1230. Side panels 1110, roof 1120, rail couplers 1210 and roof couplers 1230 are all meant to be removable and easily stored as part of modular and convertible truck bed system 1200. Side panels 1110 may optionally include windows and other features common in conventional camper shells. In one aspect, rear door 1510 may attach to roof 1120 with hinges 1520. Rear door 1510 may optionally include window 1530. In one aspect and not illustrated in FIG. 15, rear door 1510 may include a latch or other form of securing rear door 1510 to camper shell 1105. Rear door 1510 may be removable, storable and stackable along with other components of camper shell 1105. Rear door 1510 may provide additional security and weather protection for the truck bed.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for something” may be implemented as a “means configured to or suited for something”, such as a device or a circuit configured to or suited for the respective task.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to also include features of a claim to any other independent claim even if this claim is not directly made dependent on the independent claim.

What is claimed is:

1. A modular and convertible system for a truck bed comprising:
a first rail; and
a second rail mountable parallel to and spaced apart from the first rail, the first rail configured to separately secure a bicycle, the first and second rails further configured to support at least one cover selected from the group consisting of a bed cover and a camper shell.

2. The system of claim 1 further comprising:
a detachable first wheel lock coupled to the first rail and configured to engage against a wheel.

3. The system of claim 2 further comprising:
a detachable second wheel lock coupled to the first rail and offset from the first wheel lock, the second wheel lock configured to engage against a wheel that is different from the wheel engaged by the first wheel lock.

4. The system of claim 1, the first and second rails forming a plane, the system further comprising:
a plurality of bed cover planks, each bed cover plank detachably coupled to and secured between the first and second rails, each of the bed cover planks within the plane formed by the first and second rails.

5. The system of claim 4, wherein each of the first and second rails further include a horizontal channel along the length of each rail, each of the plurality of bed cover planks configured to engage with the horizontal channel along the length of each rail and, staying between the first and second rails, slide along the horizontal channel along the length of each rail.

6. The system of claim 1, the first and second rails forming a plane, the system further comprising:
a plurality of camper shell panels, each camper shell panel detachably coupled to at least one of the first and second rails, each camper shell panel extending away from the plane formed by the first and second rail.

7. The system of claim 6, the plurality of camper shell panels further comprising
a first camper shell panel and a second camper shell panel, the first camper shell panel detachably coupled to the first rail, the second camper shell panel detachably coupled to the second rail, the system further comprising:
a third camper shell panel coupled between the first camper shell panel and the second camper shell panel, the third camper shell panel having a plane parallel to the plane formed by the first and second rail, the first and second camper shell panels each separately having a plane forming an angle with the plane formed by the first and second rail.

8. The system of claim 3, the second rail configured to separately secure a bicycle, the system further comprising:
a detachable third wheel lock coupled to the second rail; and
a detachable fourth wheel lock coupled to the second rail and offset from the third wheel lock.

9. A rail for supporting a modular and convertible truck bed system, comprising:
the rail having a top, a bottom, a left side and a right side, the top of the rail having a depression along the length of the rail, the left side of the rail having a mounting point, the right side of the rail having a mounting point, the bottom of the rail having a mounting point.

10. The rail of claim 9, wherein the rail is approximately the length of a truck bed sidewall.

11. The rail of claim 9, wherein the depression along the length of the rail is a V-groove.

12. The rail of claim 11, wherein the mounting point on the left side of the rail is a channel along the length of the rail.

13. The rail of claim 12, wherein the mounting point on the right side of the rail is a channel along the length of the rail.

14. The rail of claim 13, wherein the channels on the left and right sides of the rail are T-channels.

15. The rail of claim 14, wherein the rail has a left half and a right half along a top-down bisection of the rail, the left half being a mirror image of the right half.

16. A truck bed system for securing a bicycle, comprising:
a rail configured for mounting to a sidewall of a truck bed, the rail having a top and a depression running along the top of the rail for securing a wheel of a bicycle;
a first wheel lock adjustably coupled to the rail and configured to be positioned at a plurality of points along the rail; and
a second wheel lock coupled to the rail, the second wheel lock adjustable in length.

17. The system of claim 16, wherein the first wheel lock is slidable along the rail and the second wheel lock is rotatably coupled to the rail.

18. The system of claim 16, wherein the rail has a length approximately equal to that of the truck bed side wall.

19. The system of claim 16, wherein the first and second wheel locks are removable from the rail.

20. The system of claim 16, wherein the first and second wheel locks are interchangeable with each other.

21. The system of claim 16, wherein the rail further provides a base for a camper shell.

22. The system of claim 16, wherein the rail further provides a base for a bed cover.
